(19) United States
(12) Patent Application Publication
(10) Pub. No.: US 2024/0031142 A1
(43) Pub. Date: Jan. 25, 2024

(54) RANDOM DATA GENERATOR

(71) Applicant: COMMONWEALTH SCIENTIFIC AND INDUSTRIAL RESEARCH ORGANISATION, Acton (AU)

(72) Inventors: Seyit CAMTEPE, Acton (AU); George HOBBS, Acton (AU); Garrison (Yansong) GAO, Acton (AU); Josef PIEPRZYK, Acton (AU)

(21) Appl. No.: 18/255,046

(22) PCT Filed: Dec. 3, 2021
(86) PCT No.: PCT/AU2021/051440

§ 371 Date: May 30, 2023

(30) Foreign Application Priority Data
Dec. 4, 2020 (AU) 2020904501

(51) Int. Cl. H04L 9/08; H04L 9/30

(52) U.S. Cl. CPC H04L 9/0869; H04L 9/3033

(57) ABSTRACT

This disclosure relates to generating and sharing random data. A data port receives intensity data indicative of a measured intensity of electromagnetic radiation radiated from a rotating star over an observation time period. A processor transmits configuration data to a receiving device, which is indicative of an observation time period and an identification of the rotating star. The processor then identifies multiple pulses in the intensity data, each of the multiple pulses being associated with a pulse intensity value and generates the random data by generating multiple digital data values based on the pulse intensity value. The configuration data enables the receiving device to generate the random data. Transmitting the observation time period and the identification of the rotating star enables another device to generate the random data without receiving the random data directly, or to verify that received random data has not been tampered with.

### CROSS-REFERENCE TO RELATED APPLICATIONS

The present application claims priority from Australian Provisional Patent Application No 2020904501 filed on 4 Dec. 2020, the contents of which are incorporated herein by reference in their entirety.

### TECHNICAL FIELD

This disclosure relates to generating and sharing random data.

### BACKGROUND

Random data is important for a wide range of applications in computer science. Importantly, cryptographic algorithms rely on random data for cryptographic keys, blinding factors, salt values, etc. This opens the door for attackers to provide purported random data, which in fact is not random but gives the attacker an advantage for breaking the encryption. For example, if the purported random data includes correlations, it may reduce the number of attempts required for a brute force attack, thereby reducing the required time to break the encryption.

There are a number of high quality random sources, such as thermal noise. However, after the random data is generated, it could be shared with modifications, leading to potential weakness. The problem with a trusted provider of cryptographic material is exemplified by the controversy about the Dual_EC_DRBG algorithm provided by the National Institute of Standards and Technology (NIST). It is difficult for the public to verify whether the material is secure or whether it has been modified (intentionally or not).

Another difficulty is that most physical sources of randomness are observable only where the randomness is generated. For example, thermal noise can only be observed in the same chip where it is measured. This makes sharing random data from the source, or sharing access to the source, difficult.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

Disclosed herein is a method for generating and sharing random data. The method enables public verification of the random data, which means it is no longer necessary to trust an issuer of the random data. This is achieved by extracting the random data from intensity values of pulses generated by a specific pulsar over a specific time. Sharing the pulsar identity and the time enables the public to also generate the random data and compare it to the purported random data.

A method for generating and sharing random data comprises:
transmitting configuration data to a receiving device, the configuration data being indicative of an observation time period and an identification of a rotating star;
receiving intensity data indicative of a measured intensity of electromagnetic radiation radiated from the rotating star over the observation time period;
identifying multiple pulses in the intensity data, each of the multiple pulses being associated with a pulse intensity value; and
generating the random data by generating multiple digital data values based on the pulse intensity value associated with each of the multiple pulses; wherein
the configuration data enables the receiving device to generate the random data.

It is an advantage that rotating stars are observable from multiple locations on the Earth and in space. Further, the pulse intensities provide a high level of randomness. Transmitting the observation time period and the identification of the rotating star enables a remote receiving device to generate the random data without receiving the random data directly, or to verify that received random data has not been tampered with. As a result, the method generates publicly verifiable random data, which reduces the security risk of attackers providing non-random data.

In some embodiments, the random data is a cryptographic key.

In some embodiments, the cryptographic key is a publicly trusted reference key.

In some embodiments, the cryptographic key is a public key.

In some embodiments, the rotating star is a pulsar.

In some embodiments, generating the multiple digital data values comprises generating one or more digital data values for each of the multiple pulses.

In some embodiments, generating the digital data values comprises comparing the pulse intensity value against a threshold and selecting one of two possible binary values based on whether the intensity value is above or below the threshold.

In some embodiments, the threshold is based on the pulse intensity value associated with each of the multiple pulses.

In some embodiments, the threshold is based on the pulse intensity value associated with each of multiple pulses within a time window immediately before the pulse intensity value used to generate the digital data.

In some embodiments, the threshold is a median value of the pulse intensity value associated with each of the multiple pulses.

In some embodiments, the method further comprises repeatedly updating the threshold value based on recent pulse intensity values.

In some embodiments, generating the digital data values comprises:
comparing a first pulse intensity value to a second pulse intensity value, being immediately after the first pulse intensity value; and
generating one or more of the digital data values based on the comparison.

In some embodiments, the method comprises selecting one of two possible binary values based on whether the first pulse intensity value is less or greater than the second pulse intensity value.

In some embodiments, the method is performed in a first iteration and repeated in a second iteration to generate further one or more of the digital data values, and the first pulse intensity value of the second iteration is the second pulse intensity value of the first iteration.

In some embodiments, the method is performed in a first iteration and repeated in a second iteration to generate further one or more of the digital data values, and the first pulse intensity value of the second iteration is after the second pulse intensity value of the first iteration.

Software, when performed by a computer, causes the computer to perform the above method.

A computer system for generating and sharing random data comprises:
a data port configured to receive intensity data indicative of a measured intensity of electromagnetic radiation radiated from a rotating star over an observation time period;
a processor configured to:
   transmit configuration data to a receiving device, the configuration data being indicative of an observation time period and an identification of the rotating star;
   identify multiple pulses in the intensity data, each of the multiple pulses being associated with a pulse intensity value; and
   generate the random data by generating multiple digital data values based on the pulse intensity value associated with each of the multiple pulses; wherein the configuration data enables the receiving device to generate the random data.

A method for generating and sharing random data comprises:
receiving configuration data, the configuration data being indicative of an observation time period and an identification of a rotating star;
determining intensity data indicative of a measured intensity of electromagnetic radiation radiated from the rotating star over the observation time period;
identifying multiple pulses in the intensity data, each of the multiple pulses being associated with a pulse intensity value; and
generating the random data by generating multiple digital data values based on the pulse intensity value associated with each of the multiple pulses.

Optional features that have been disclosed above in relation to the method, are to be understood to be optional features of the other aspects including the system, method and software.

### BRIEF DESCRIPTION OF DRAWINGS

An example will now be described with reference to the following drawings:

FIG. 1a illustrates an example scenario comprising a rotating star and the Earth.

FIG. 1b illustrates a computer system for generating random data.

FIG. 1c illustrates a method for generating and sharing random data.

FIG. 2 shows signals from PSR B0950+08 pulsar obtained on UTC 2019-09-25.

FIG. 3 shows a sample of pulses extracted from the data in FIG. 2. The time between pulses is stable and represents the rotation of the star. The signal strength for each pulse varies and can be used in producing random number sequences.

FIG. 4 illustrates the extraction of bit sequences from pulses, dots above the horizontal line result in 1 and below 0.

FIG. 5 illustrates a histogram of intensity peak values of J0437-4715 that follow a log-normal distribution.

FIG. 6 illustrates threshold-based bit extraction. From top to bottom: i) raw pulse data; ii) peaks are identified; iii) median—horizontal line—is determined and acts as a threshold; iv) random binary sequence is generated by comparing the peak with the threshold.

FIG. 7 illustrates the median value change across the observations.

FIG. 8 illustrates differential-based bit extraction. From top to bottom: i)—raw pulse data; ii)—peaks; iii)—differential comparison between two consecutive pulses.

FIG. 9 illustrates results from randomness tests.

FIG. 10 illustrates a scenario of shared randomness involving four receivers.

FIG. 11 illustrates an example of the same pulse sequence being observed at two different observatories. We see that the same sequence of pulse intensities could be obtained using two geographically separated observatories.

### DESCRIPTION OF EMBODIMENTS

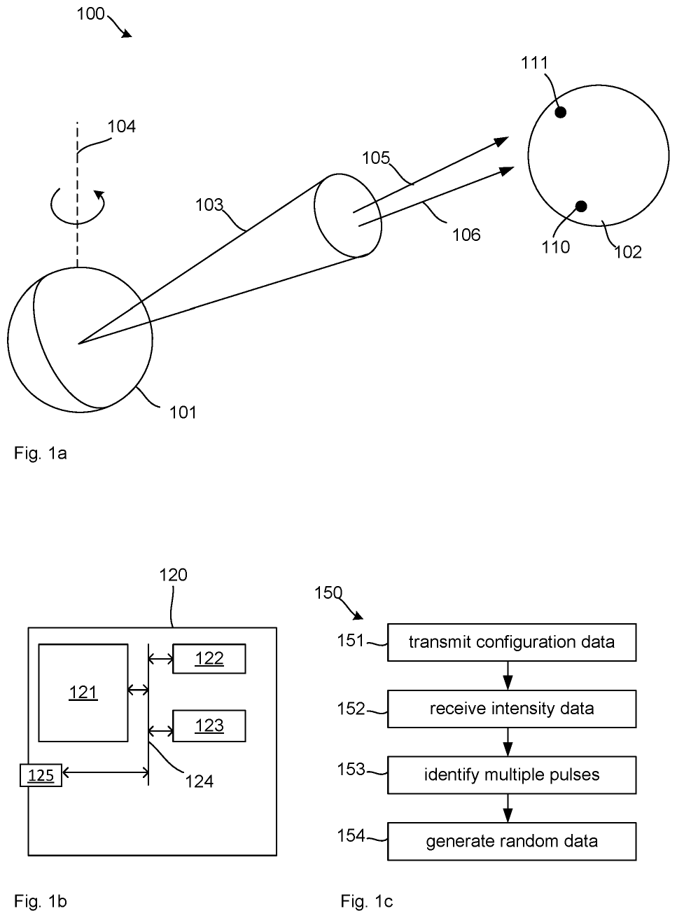

FIG. 1a illustrates an example scenario 100 comprising a rotating star 101 and the Earth 102. In this example, rotating star 101 is a pulsar. Pulsars are fast spinning (up to 700 times/second) stars that were formed in supernovae. They are approximately 25 km is diameter and have strong magnetic fields. Radio pulsars produce a beam (103) of radio emission. For misaligned magnetic and rotational axes, the beam sweeps through the sky and are detected as radio pulses using a radio telescope. Over 2000 pulsars are currently known.

There are two locations 110 and 111 shown on Earth 102, which indicate locations of communications partners who want to share common random data. From both locations 110 and 111, the pulsar 101 can be observed in the sky. Depending on the intensity of pulsar 101, the communication partners may deploy radio telescopes, such as antenna dishes, to detect the pulsar signal.

### Computer System

FIG. 1b illustrates a computer system 120, which may be located at each of locations 110 and 111. Computer system 120 comprises a processor 121, program memory 122 and data memory 123, which are connected with processor 121 via data bus 124. There is also a communication interface 125 to communicate with the computer system at the other location and to receive intensity data from a radio telescope, an antenna, or previously stored data from a database. The database may also be integrated into computer system 120, which is not shown in FIG. 1b. It is to be understood that a wide variety of different computer systems can be used to implement the methods disclosed herein, such as personal computers, smart phones, tablets, cloud computing systems, microcontrollers, field programmable gate arrays, application specific integrated circuits and others.

Program memory 122 is non-volatile, computer-readable medium that has software code stored thereon, which, when executed by processor 121, causes processor 121 to perform the methods disclosed herein.

FIG. 1c illustrates a method 150, as performed by processor 121, for generating and sharing random data. According to method 150, processor 121 transmits 151 configuration data to a receiving device. For example, if processor 121 is located at first location 110, then the receiving device is the computer system located at the second location 111. The configuration data is indicative of the observation time period and an identification of the rotating star, to enable the receiving device to generate the random data. So for example, the configuration data can be a tuple of data values including the observation time period and star identification, such as the name of the star or its coordinates in the sky.

Processor 121 may select a pulsar and determines an observation time window. This selection and determination may be based on a variety of factors. For example, processor 121 may obtain the geographical coordinates of first location 110 and second location 111 and may then select a pulsar that is visible from both locations. The processor may also be used to identify the observation times (if any) that a given pulsar would be visible at both locations at the same time. In yet a further example, processor 121 may select a pulsar based on a desired pulsar intensity, such that the pulsar is only detectable by telescope above a minimum diameter, so as to reduce the risk of attackers obtaining the same random data.

Processor 121 then receives 152 intensity data indicative of a measured intensity of electromagnetic radiation radiated from a rotating star over an observation time period. The intensity data may comprise digital data comprising an intensity value for each of multiple points in time. In another example, the received intensity data is in a transformed space, for instance, the pulse data may be provided as Fourier coefficients or in a wavelet space and the data may have been pre-calibrated, or processed. Processor 121 then identifies 153 multiple pulses in the intensity data, which occurred as a result of beam 103 passing the line of sight from the observer to the pulsar 102 in FIG. 1a. Each of the multiple pulses are associated with a pulse intensity value, which may be indicative of the field strength or energy captured by the telescope or antenna. Further, processor 121 may receive intensity data and integrate the area under the curve defined by the intensity data to calculate and save the energy of each pulse. Processor 121 may further calibrate the data based on the observation that the electromagnetic wave may have multiple polarisation components, which may be represented by four numbers for each time point. Processor 121 may make the calculations disclosed herein in any polarisation, any of the four numbers, in isolation or in combination.

Processor 121 then generates 154 the random data by generating multiple digital data values based on the pulse intensity value associated with each of the multiple pulses. Generating data values based on intensity values means that the processor 121 processes the pulse intensity values, such as by applying a mathematical calculation to them, and the output provides the digital data values. in other words, the intensity values are arguments or inputs of a function performed by processor 121 and the data values are the return values or outputs of the function. As explained further below, a data value may be a zero if the intensity value is below a threshold and one if the intensity value is above a threshold. In another example, the data value is zero if the intensity value is less than the previous intensity value and one if the intensity value is greater than the previous intensity value.

It is noted that transmitting the configuration data (step 151) may occur at any point in time and does not need to occur before the random data has been generated in step 154 In that sense, processor 121 can generate the random data and then transmit the configuration data so that the receiving device can access a database of stored historical pulsar observations.

By sending the configuration data, processor 121 enables the receiving device to generate the random data. In yet another example, processor 121 may also send the random data and the receiving device can use the configuration data to receive the intensity data and generate random data from the intensity data over the given time period. The receiving device can then compare the locally generated random data to the random data received from processor 121. If both match, the random data is verified. In other examples, the receiving device only receives a hash value of the random data and calculates a hash value of the locally generated random data. If both hash values match, the random data is verified.

In one example, the receiving device and/or processor 121 use the random data as a one-time-pad or cryptographic key. The cryptographic key can be used for symmetric cryptography to encrypt and decrypt data in a two- or multi-party communication. The cryptographic key can therefore be a trusted reference key, where the public can verify that the key has not been tampered with. Further keys, such as actual encryption and decryption keys can then be derived from the reference key Further, the cryptographic key can be a public key in the sense that the public key is available publicly and usable to encrypt data or verify signatures. The public key is cryptographically linked to a private key that is kept secret and usable for decryption and calculating signatures. In other examples, these devices use the random data as a seed for a pseudo-random generator, which then generates the actual cryptographic keys, rolling codes, nonces or other cryptographic data.

### Pulses

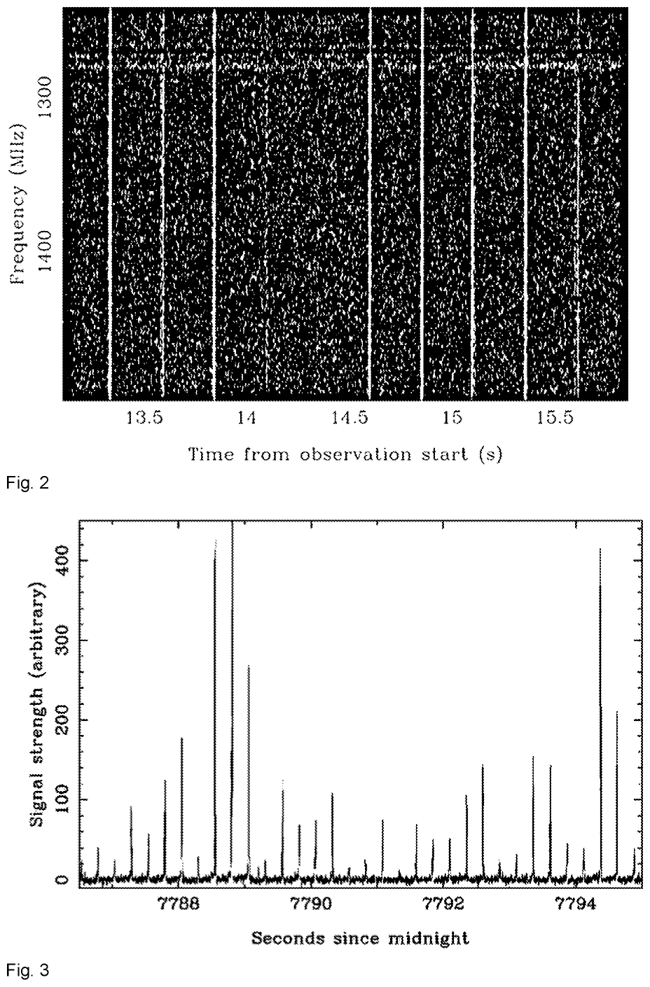

The pulses emitted by pulsars are relatively stable and predictable, e.g., the period of PSR J1603-7202 increases by just 0.0000005 seconds every million years. FIG. 2 shows signals from PSR B0950+08 pulsar obtained on UTC 2019-09-25. Each pixel (time and frequency) in the figure has been sampled with 2-bits. The observation used the Parkes multi-beam receiver and the PDFB4 backend system giving 256 MHz of bandwidth, 64 us sampling and 512 frequency channels. using the Digital Signal Processing for Pulsars (dspsr) program to extract single pulses. It can be observed that pulses arrive earlier at higher frequencies and not all pulses have the same intensity. The time signal is shown in FIG. 3, which is the result of pre-processing of this raw data of FIG. 2 (e.g., summing up observations at a specific time to produce a time series as in FIG. 3). Finally, the resulting data is used in different ways (median, pulse differentiator, etc.) to extract bit sequences. The resulting bit sequence is error corrected in shared randomness scenario, tested for randomness and further processed for randomness amplification.

The signal in FIG. 3 also carry erratic components. As can be seen in FIG. 3, the pulse period is relatively stable (the pulses appear at regular intervals), but the intensity, that is the height/amplitude of each pulse varies. The baseline level between consecutive pulses contains noise from the background signal and from the instrumentation. Additionally, each pulse has a different shape: irregular size peaks appear at irregular intervals, giant pulses or nulls (where a pulsar skips pulses) at irregular intervals.

### Preparing the Dataset

Archival data, such as from the Commonwealth Scientific and Industrial Research Organisation (CSIRO) Astronomy and Space Science (CASS) is mined to find observations suitable for testing and demonstrating the methods. Once such observations are found, they pass through a sequence of scripts which were prepared and regularly used by CASS. These scripts prepare a file with two-dimensional data points (time and intensity). Alternatively, processor 121 may also process the data received from the telescope and identify pulses. Since the main objective is identifying pulses and their respective peak intensity, removing noise and other processing steps may not be required.

### Randomness Analysis Software Platform

The platform disclose herein may include a set of open-source randomness testing tools such as Dieharder, TestU01, and NIST 800-90b. These tools are useful in testing uniform random distributions.

Analysis of the pulsar dataset: One of the aspects is to identify and extract features which can be transformed into bit sequences. This disclosure focusses on features which may show the similarity between observations made by dishes having different sizes. These include signal intensity, nulls and giants. The platform includes several methods (e.g., median) to extract bits representing a uniformly random sequence and permits implementation of new methods.

This disclosure provides a method for generating publicly verifiable physical randomness from natural sources in space, far from potential human influences. In general, a source of public randomness should satisfy five properties. This disclosure shows that pulsar randomness is a natural (true) randomness source which can satisfy those properties.

Availability, where no party should able to block access to the source and any party, can access the source anytime. Pulsars, as the natural randomness sources, has the advantage that they are not human-made, or they cannot be influenced human being in any way. An example of a bright pulsar is J0437-4715, which is 510 light-years distant. Such distances make these sources observable throughout the solar system. Moreover, considering the number of known pulsars, it is not a challenge to find many pulsars to observe at any time of the year from any location on the earth and in the solar system. These make pulsars good sources of randomness (and positioning) in moon-to-mars and space mining type of future missions.

Unpredictability, where no party should be able to predict (precompute) future random bits. Research on pulsars shows that pulsar signals have many features which have random characteristics. The signals we receive today might have been generated more than 50 million years ago, no results is showing that pulsar features carry any pattern and they can be predicted. Collected data so far passes the applicable NIST randomness tests.

Non-Malleability, where no party should able to influence the future random bits to their advantage. Pulsar signals are coming from several hundred to 10 s of million light-years distant. This also means that the signals we monitor today are originated hundreds to 10 s of million years back. The number of pulsars and the distance makes it infeasible to intercept these signals before they reach to observation points.

Public-Verifiability, where any party should be able to verify the correctness of generated bits. Universal accessibility to signal means that anybody can monitor and extract the bit sequences required that they have the knowledge of signal processing algorithms. Hence, bit sequences obtained from pulsars are publicly verifiable.

No-Trusted Server, where no trusted server needed to activate and manage the randomness source. Randomness extraction from pulsars can be done without the need of any trusted party, at the point where the signals are monitored.

### Datasets (Existing, New Observations, Simulations)

Some examples disclosed herein use the observations from PSR J0437-4715 and B0950+08. Both pulsars are bright. PSR J0437-4715 is in the Southern sky, whereas B0950+08 can be seen from both the Northern and Southern hemispheres. These are used because:
Better signal to noise characteristics; consequently, different bit extraction schemes can be evaluated to assess the impact of noise level (e.g., due to receiver size and technology) on the quality and quantity of the extracted randomness.
More observations in the decades of CASS data repository as these are popular pulsars for pulsar astronomers.
Potential to observe with smaller receivers, in the multi-receiver and shared randomness scenarios.
J0437-4715 is a fast rotating pulsar with the pulse period of 5.76 ms, whereas B0950+08 is a slower rotating pulsar with a pulse period of 0.25 s.

The CASS repository has been mined to process past observations spread over the years. Further, PSR J0437-4715 was observed with the Parkes Telescope, Parkes, Australia, for 2 hours to observe more than 1.25 million pulses. These long observations are valuable because data collected out of a set of smaller observations may have variations due to calibration issues—differences in the median values of pulse signal intensity.

The third type of dataset that the team has been used is simulated data. This way, as many pulses as required can be generated (limited by storage) this way in minutes.

### Extraction Methods

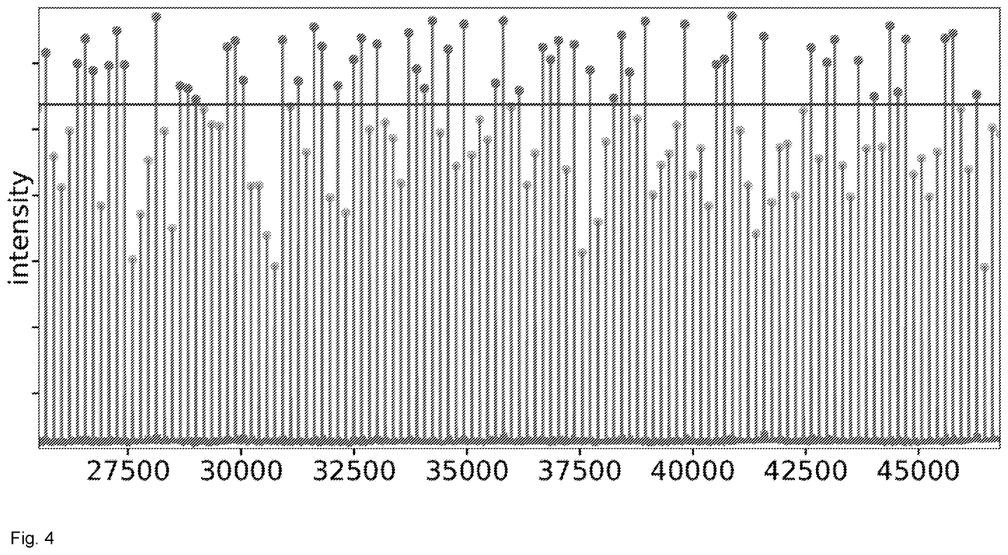

The following disclosure provides ways of extracting digital, binary random data from the intensity data, that is, the measured intensity of electromagnetic radiation radiate from the pulsar over an observation period. These processes are typically performed by computer systems, such as computer system 120, or simply ‘computers’ herein. FIG. 4 shows an example where pulses with an intensity above the horizontal line generate a ‘1’ and below the line the pulses generate a ‘0’.

It would be preferable to extract as many bits as possible from a single pulse in the intensity data while preserving the level of randomness. The reason is that potential applications that may use pulsar randomness may be consuming random sequences very fast. On the other side, millisecond pulsars can only produce a pulse in several milliseconds (e.g., the pulse period for J0437-4715 is 5.76 ms). Noise level (e.g., receiver size and sensitivity) plays a significant role in the number of bits extracted from a pulse.

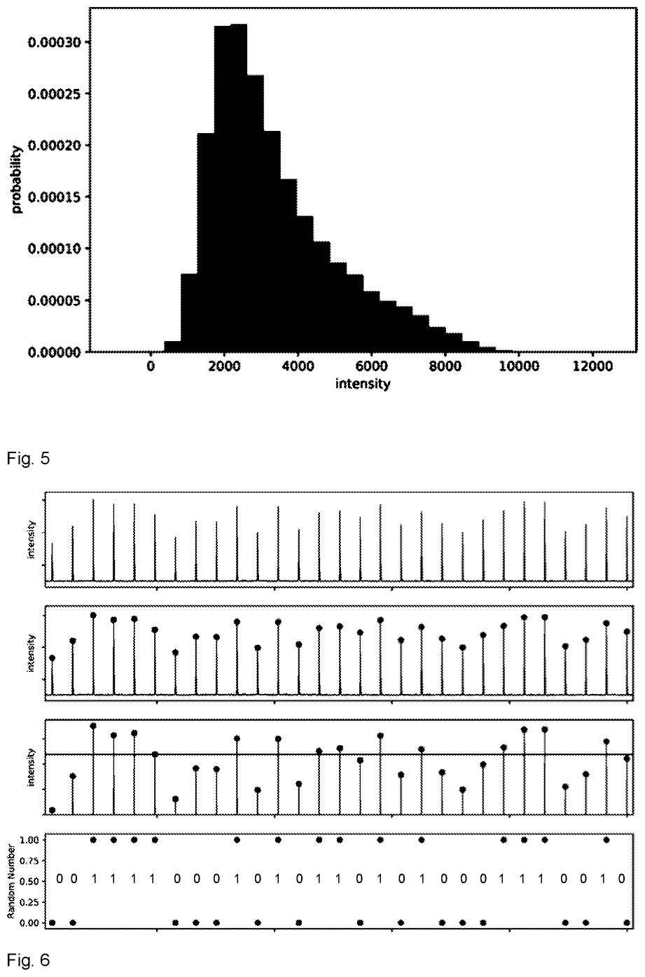

Another observation is that pulse intensities show log-normal distribution. FIG. 5 illustrates that the distribution of the intensity peak values of PSR J0437-4715 follows a log-normal distribution as expected (54,726 pulses from CASS data repository). It should be noted that some known random number generators and randomness tests assume uniform distribution.

Period of the pulses is a known parameter and stored on the computer system, so that the processor can define or retrieve a time window to detect the intensity peak, which is alike the amplitude of the arriving pulse. Other statistical values can also be used. One example is as follows. The time window may be centred around a point in time that has a distance from the previous peak of the expected period. The width of the time window may be a 10^{th} or a 100^{th} of the expected time period. The processor may perform a peak detection methods within the detection window, such as finding the maximum or by applying a matched filter. The peak value is then the maximum amplitude of the sample of the intensity signal. In further examples, the maximum amplitude is interpolated between two samples, such as by a linear interpolation or fitting a Gaussian shape or similar. The peak intensity varies from pulse to pulse and is unpredictable. There are different approaches to extract random bits from pulses according to the detected peaks. This disclosure provides two general approaches: threshold based and differential based. Both approaches generate one or more digital data values (i.e. bits) for each of the multiple pulses.

### Threshold Based Extraction

This approach builds upon a threshold. The processor 121 compares the peak value with a threshold to produce binary bits, so this approach generates exactly one bit for each of the multiple pulses. In other examples, multiple bits can be extracted from a single pulse according to the comparison with the threshold. The entropy is higher when a single bit is extracted from a single pulse. Processor 121 follows the steps below:
Threshold Determination. The median value of peaks acts as the threshold. To be precise, the peak value of a number of consecutive pulses, such as 10 or 100 pulses, are averaged. The higher the number, the smaller the variance of this threshold being close to the mean value.
Random Bit Extraction. Once the threshold is determined, the peak value of each pulse is simply compared with the threshold in order to select one of two possible binary values (1/0, High/Low, True/False) based on whether the intensity value is above or below the threshold. That is, the random bit is ‘ 1’ if the peak value is larger than the threshold, otherwise, it is ‘0’.

The extraction steps are visualised in FIG. 6, where one pulse produces a 1-bit random number. From top to bottom: i) raw pulse data; ii) peaks are identified; iii) median—horizontal line—is determined and acts as a threshold; iv) random binary sequence is generated by comparing the peak with the threshold.

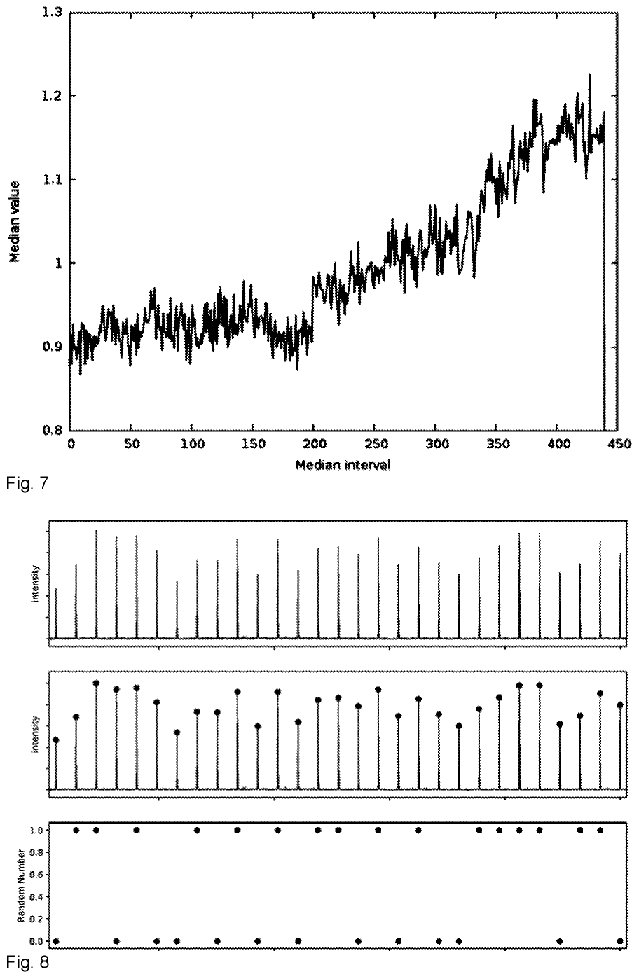

It is desirable that this threshold is pre-set. When the processor 121 receives a new pulse, the peak value of the incoming pulse can directly be compared with the pre-set threshold to extract binary bits. However, in practice, the median/threshold may vary slightly. The reason is that the telescope sensitivity (gain) changes with time. If not calibrated, the median value goes up and down (FIG. 7). The pulse signal also intrinsically varies (i.e., variations in the interstellar medium between the pulsar and Earth) which causes variations in the mean.

Therefore, the threshold-based method may have problem of guaranteeing a constant threshold to ensure the goodness of the randomness. This issue can be eliminated by having a threshold that is based on the pulse intensity value associated with each of the multiple pulses, such as via running median, where the median is updated dynamically based on a fixed number of latest consecutive pulses within a time window immediately before the pulse that is being used to extract the digital date. In one example, the time window has a size of 10,000 pulses, noted that the time of the window can be measured in pulses, similar to ‘ticks’. The threshold may be updated repeatedly based on the intensity values as explained before. The threshold may also be updated continuously, which means that the threshold is calculated for each pulse.

While a single threshold is used as an example above, other examples may use multiple threshold to define four “intensity bands” for example and each band is associated with a two-bit random number, such as 00, 01, 10, 11, for each band respectively. This way, processor 121 generates as the output random data, the two-bit number associated with the band in which the associated intensity was observed.

### Differential-Based Extraction

In another example, processor 121 compares two peaks differentially to generate a 1-bit random binary. In other words, processor 121 compares a first pulse intensity value to a second pulse intensity value, being immediately after the first pulse intensity value and generates the digital data values based on the comparison. Supposing that there are M pulses/peaks, first, the processor can compare peaks of m^{th} with (m+1)^{th} pulses to produce M−1 binary bits, as visualised in FIG. 8 (from top: i)—raw pulse data; ii)—peaks; iii)—differential comparison between two consecutive pulses). In other words, processor 121 performs a first iteration to compare m^{th} with (m+1)^{th} pulses and repeats that in a second iteration comparing (m+1)^{th} to (m+2)^{th} pulses. That is, the first pulse intensity value of the second iteration is the second pulse intensity value of the first iteration.

Second, processor can compare peaks of m^{th} with (m+1)^{th} pulses and then (m+2)^{th} with (m+3)^{th} pulses to produce M/2 binary bits.

The first differential method generates 1-bit binary number per pulse—termed as the overlapped differential method. While the second differential method generates 1-bit binary number per two pulses-termed as the non-overlapped different method. For both methods, the output binary value is based on whether the first intensity value is less or greater than the second pulse intensity value. In comparison with threshold-based methods, one main advantage is that differential based methods require no predetermined threshold.

### Randomness Tests

IST SP800-22b (NIST for short hence-after) statistical test suite is unitised to test the randomness of the extracted binary sequences. The NIST statistical test suite consists of 15 tests that verify the randomness of a binary sequence. These tests focus on various types of non-randomness that can exist in a sequence. Each test has specific length requirement of the fed sequence. For example, Frequency test is 100, while Linear Complexity test is 1,000,000. On the other hand, to obtain meaningful P-Value, at least 55 sequences/substrings should be tested. Therefore, in the following, we only present the test results which can meet the above conditions. Pulses are from same telescope but collected from four past observations (CASS datasets)—with 54,724 pulses, 59,003 pulses, 90,417 pulses and 75,396 pulses. In total, 279,540 pulses are concatenated and used for randomness tests.

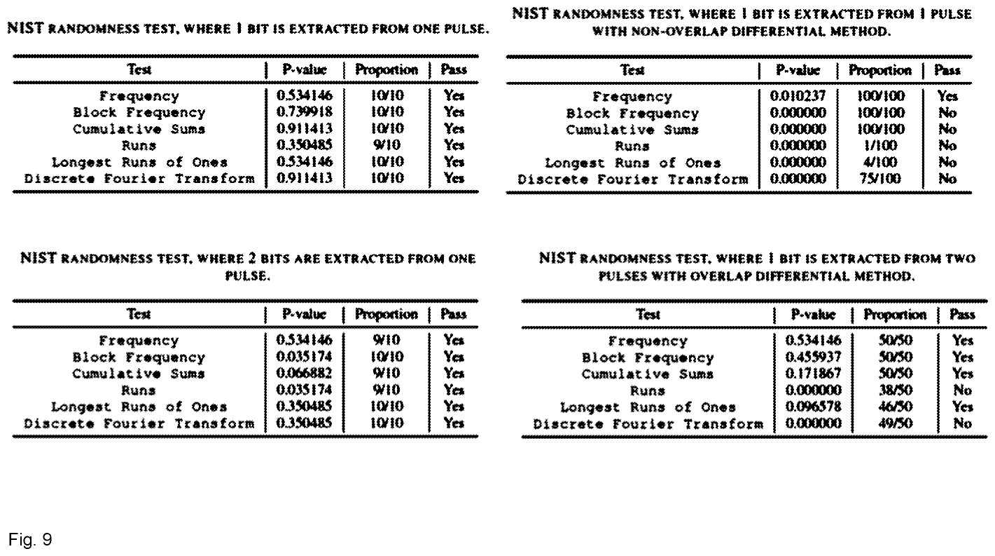

Threshold based: 1-bit per pulse. Considering the total number of bits (54,726), the testing sequence in the NIST test is set to be 5,000; therefore, there are ten testing sequences evaluated. Because each sequence is short, four tests are performed. Results are detailed in FIG. 9 (top-left). From the results, we can see all the tests pass as the P-value is higher than 0.01.

Threshold based: 2-bit per pulse. The number of bits extracted is doubled to 109,452, 10 testing sequences are similarly applied: each testing sequence is with 5,000 bits. Results are detailed in FIG. 9 (bottom-left). Though all the tests pass, the P-value decreases greatly when 2 bits are extracted from a single pulse-entropy per bit becomes lower. Hence, in practice, it is favourable to extract only 1-bit per pulse.

Differential based: overlap. The number of bits extracted is 54,725-1 bit per pulse. Each substring is 500 bits and 100 substrings are tested. Results are detailed in FIG. 9 (top-right).

Differential based: non-overlap. The number of bits extracted is 27,363-1 bit per two pulses. Each substring is 500 bits and 50 substrings are tested. Results are detailed in FIG. 9 (bottom-right). In comparison with the overlapped differential method, the non-overlapped differential method appears to have better randomness. A potential reason is that two consecutive bits in the overlapped differential method share one pulse, which may decrease the randomness of extracted bits.

### Shared Randomness

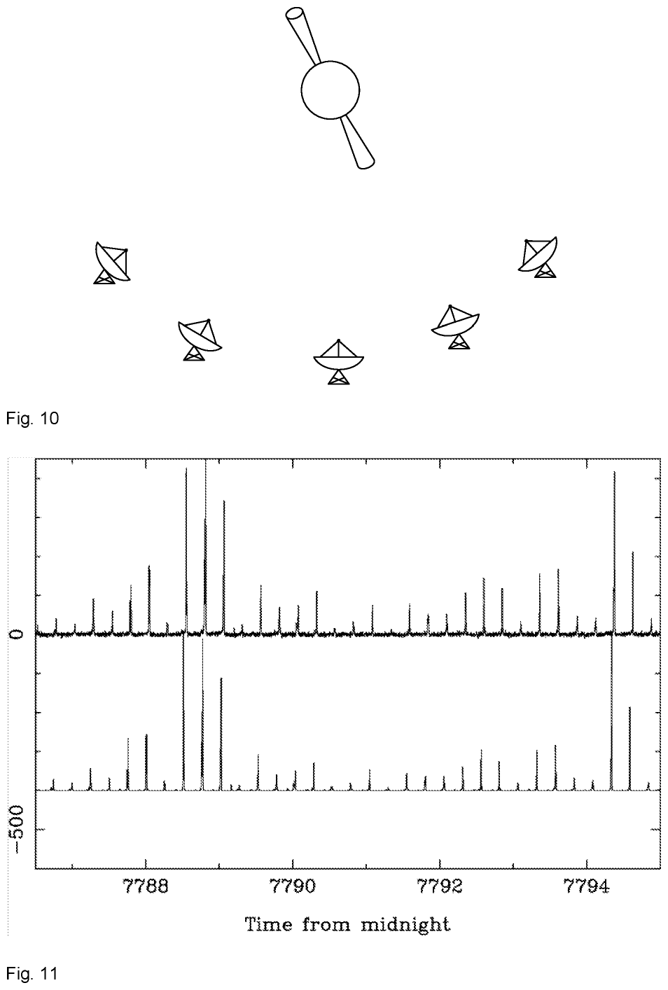

Pulsars are public (universal) sources of randomness which brings several advantages. Firstly, single pulsar randomness can be shared by all parties within or beyond the Earth's atmosphere, as long as these parties agree on and observe a pulsar at the same time (FIG. 10). Next, the randomness source is not subject to adversarial manipulation (governed by the laws of physics) and thus can be trusted. Moreover, many pulsars can be chosen as a source of randomness. Then, resource-rich players with large dishes may use pulsars that emit very faint radiation making the extracted randomness resistant against weaker adversaries (with small receivers). Finally, regular pulses can be considered as embedded timing signals which can help multiple parties to synchronize and start extraction at the right pulse in time.

FIG. 11 shows a synchronized observation of a pulsar (PSR B0950+08) by two receivers obtained on UTC 2019-09-25. The same pulse sequence being observed at two different observatories. We see that the same sequence of pulse intensities could be obtained using two geographically separated observatories. While receivers experience a different level of noise due to size difference, the plot shows that shared randomness between distant observers is feasible and achievable. The processor 121 may follow the protocol below to ensure that parties can reach a consensus, i.e., a matching random bit sequence.

Propose: Propose phase defines the starting and observation length, makes an agreement of choosing a specific pulsar as a randomness source. Also, the requester will be identified. One convenient solution is that all participants agree with an interval to refresh the random output. This interval is determined by the entropy of the randomness source and random bit rate to ensure that sufficient random bits are provided during this interval. During the propose phase, the participants transmit what is referred to above as configuration data.

Acknowledge: The requester computes helper data and publishes it. At the same time, its random sequence is published as well.

Verification: Each participant applies error correction assisted with the random sequence produced by herself and the helper data released by the requester. This process allows each participant to recover the same random sequence.

### Security

There is one method which may be unconditionally secure (i.e., no matter what algorithm or computational power), it is called one-time-pad. One-time-pad based security uses a key as long as the message size, which is random and never used again. With known random number generators, it is difficult to generate such never-repeating shared keys. This disclosure provides a practical unconditionally secure method based on a source to provide shared randomness for practical one-time-pad schemes. In particular, the communicating parties may have access to a significantly larger telescope dish than the telescope dish in the hands of an adversary and it should be infeasible to observe the pulsar with dish sizes used by the adversary. So an overwhelming majority of bits are not known.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

### Example Pulsars

The table below provides example pulsars that may be used. Further pulsars can be found at https://www.atnfcsiro.au/research/pulsar/psrcat/, for example, or other public databases. The columns contain the pulsar traditional name (NAME), its Julian 2000 name (PSRJ), the sky position (RAJ and DECJ) and its flux density in the 20 cm observing band (S1400).

| | | RAJ | DECJ | S1400 |
|---|---|---|---|---|
| NAME | PSRJ | (hms) | (dms) | (mJy) |
| B0833 − 45 | J0835 − 4510 | 08:35:20.6 | −45:10:34.8 | 1050.00 |
| B1641 − 45 | J1644 − 4559 | 16:44:49.2 | −45:59:09.5 | 300.00 |
| B0329 + 54 | J0332 + 5434 | 03:32:59.3 | +54:34:43.5 | 203.00 |
| J0437 − 4715 | J0437 − 4715 | 04:37:15.8 | −47:15:09.1 | 160.00 |
| B0950 + 08 | J0953 + 0755 | 09:53:09.3 | +07:55:35.7 | 100.00 |
| B0736 − 40 | J0738 − 4042 | 07:38:32.3 | −40:42:40.9 | 99.70 |
| B1451 − 68 | J1456 − 6843 | 14:56:00.1 | −68:43:39.2 | 64.20 |
| B1933 + 16 | J1935 + 1616 | 19:35:47.8 | +16:16:39.9 | 57.80 |
| B1749 − 28 | J1752 − 2806 | 17:52:58.6 | −28:06:37.3 | 47.80 |
| B2020 + 28 | J2022 + 2854 | 20:22:37.0 | +28:54:23.1 | 38.00 |
| B1556 − 44 | J1559 − 4438 | 15:59:41.5 | −44:38:45.9 | 37.10 |
| B0835 − 41 | J0837 − 4135 | 08:37:21.1 | −41:35:14.3 | 35.00 |
| B1240 − 64 | J1243 − 6423 | 12:43:17.1 | −64:23:23.8 | 34.20 |
| B1054 − 62 | J1056 − 6258 | 10:56:25.5 | −62:58:47.6 | 34.00 |
| B0628 − 28 | J0630 − 2834 | 06:30:49.4 | −28:34:42.7 | 31.90 |
| B2016 + 28 | J2018 + 2839 | 20:18:03.8 | +28:39:54.2 | 30.00 |
| B1929 + 10 | J1932 + 1059 | 19:32:13.9 | +10:59:32.4 | 28.70 |
| B1727 − 47 | J1731 − 4744 | 17:31:42.1 | −47:44:34.5 | 27.00 |
| B2021 + 51 | J2022 + 5154 | 20:22:49.8 | +51:54:50.2 | 27.00 |
| B0740 − 28 | J0742 − 2822 | 07:42:49.0 | −28:22:43.7 | 26.00 |

1. A method for generating and sharing random data, the method comprising:
transmitting configuration data to a receiving device, the configuration data being indicative of an observation time period and an identification of a rotating star;
receiving intensity data indicative of a measured intensity of electromagnetic radiation radiated from the rotating star over the observation time period;
identifying multiple pulses in the intensity data, each of the multiple pulses being associated with a pulse intensity value; and
generating the random data by generating multiple digital data values based on the pulse intensity value associated with each of the multiple pulses; wherein the configuration data enables the receiving device to generate the random data.

2. The method of claim 1, wherein the random data is a cryptographic key.

3. The method of claim 2, wherein the cryptographic key is a publicly trusted reference key.

4. The method of claim 2, wherein the cryptographic key is a public key.

5. The method of claim 1, wherein the rotating star is a pulsar.

6. The method of claim 1, wherein generating the multiple digital data values comprises generating one or more digital data values for each of the multiple pulses.

7. The method of claim 6, wherein generating the digital data values comprises comparing the pulse intensity value against a threshold and selecting one of two possible binary values based on whether the intensity value is above or below the threshold.

8. The method of claim 7, wherein the threshold is based on the pulse intensity value associated with each of the multiple pulses.

9. The method of claim 8, wherein the threshold is based on the pulse intensity value associated with each of multiple pulses within a time window immediately before the pulse intensity value used to generate the digital data.

10. The method of claim 7, wherein the threshold is a median value of the pulse intensity value associated with each of the multiple pulses.

11. The method of claim 7, further comprising repeatedly updating the threshold value based on recent pulse intensity values.

12. The method of claim 1, wherein generating the digital data values comprises:
comparing a first pulse intensity value to a second pulse intensity value, being immediately after the first pulse intensity value; and
generating one or more of the digital data values based on the comparison.

13. The method of claim 12, wherein the method comprises selecting one of two possible binary values based on whether the first pulse intensity value is less or greater than the second pulse intensity value.

14. The method of claim 12 or 13, wherein the method is performed in a first iteration and repeated in a second iteration to generate further one or more of the digital data values, and the first pulse intensity value of the second iteration is the second pulse intensity value of the first iteration.

15. The method of claim 12 or 13, wherein the method is performed in a first iteration and repeated in a second iteration to generate further one or more of the digital data values, and the first pulse intensity value of the second iteration is after the second pulse intensity value of the first iteration.

16. A non-transitory computer readable medium with program code stored thereon that, when performed by a computer, causes the computer to perform the method of claim 1.

17. A computer system for generating and sharing random data, the computer system comprising:
a data port configured to receive intensity data indicative of a measured intensity of electromagnetic radiation radiated from a rotating star over an observation time period;
a processor configured to:
transmit configuration data to a receiving device, the configuration data being indicative of an observation time period and an identification of the rotating star;
identify multiple pulses in the intensity data, each of the multiple pulses being associated with a pulse intensity value; and
generate the random data by generating multiple digital data values based on the pulse intensity value associated with each of the multiple pulses; wherein the configuration data enables the receiving device to generate the random data.

18. A method for generating and sharing random data, the method comprising:
receiving configuration data, the configuration data being indicative of an observation time period and an identification of a rotating star;
determining intensity data indicative of a measured intensity of electromagnetic radiation radiated from the rotating star over the observation time period;
identifying multiple pulses in the intensity data, each of the multiple pulses being associated with a pulse intensity value; and
generating the random data by generating multiple digital data values based on the pulse intensity value associated with each of the multiple pulses.
